(19) United States
(12) Patent Application Publication
(10) Pub. No.: US 2007/0293084 A1
(43) Pub. Date: Dec. 20, 2007

(54) ELECTRICAL CONNECTORS WITH AIR-CIRCULATION FEATURES

(76) Inventor: Hung Viet Ngo, Harrisburg, PA (US)

Correspondence Address: WOODCOCK WASHBURN, LLP, CIRA CENTRE, 12TH FLOOR, 2929 ARCH STREET, PHILADELPHIA, PA, 19104-2891, US

(21) Appl. No.: 11/744,428

(22) Filed: May 4, 2007

Related U.S. Application Data
(60) Provisional application No. 60/814,275, filed on Jun. 15, 2006.

(51) Int. Cl. H01R 13/73

(52) U.S. Cl. 439/552

(57) ABSTRACT

Embodiments of electrical connectors include features that facilitate circulation of air through and around the electrical connectors. The air can cool the power contacts of the electrical connectors, thereby allowing the power contacts to operate at higher currents that would otherwise be possible.

### CROSS-REFERENCE TO RELATED APPLICATIONS

This application claims priority under 35 U.S.C. §119(e) to U.S. provisional application No. 60/814,275, filed Jun. 15, 2006, the contents of which is incorporated by reference herein in its entirety.

This application is related to patent application Ser. No. 11/019,777, filed Dec. 21, 2004; application Ser. No. 11/408,437, filed Apr. 21, 2006; the application titled “Connectors and Contacts for Transmitting Electrical Power,” filed May 26, 2006 with attorney docket no. FCI-3004/C3980, the application titled “Electrical Power Contacts and Connectors Comprising Same,” filed Jun. 9, 2006 with attorney docket no. FCI-3005/C3964, and the application titled “Electrical Power Contacts and Connectors Comprising Same,” filed Jun. 12, 2006 with attorney docket no. FCI-3003/C3624B, all of which are incorporated herein by reference.

### TECHNICAL FIELD

The present invention relates to electrical connectors for transmitting electrical power.

### BACKGROUND

Power contacts typically experience a temperature rise during operation, due the passage of electrical current therethrough. The temperature rise, if excessive, can melt or otherwise damage the power contact, its housing, and other hardware located in the vicinity of the power contact. The temperature rise in a power contact, in general, is proportional to the current level in the power contact. Thus, the maximum rated current of a power contact is typically limited by the maximum acceptable temperature rise in the power contact.

Increasing the operating current of an electronic device, in general, permits the device to operate at a lower voltage than would otherwise be possible. Manufacturers of electronic devices therefore often request or require power contacts with relatively high current ratings. Consequently, it is desirable to minimize the temperature rise experienced by power contacts during operation.

### SUMMARY

Embodiments of electrical connectors include features that facilitate circulation of air through and around the electrical connectors. The air can cool the power contacts of the electrical connectors, thereby allowing the power contacts to operate at higher currents that would otherwise be possible.

Embodiments of connector systems comprise a first electrical connector comprising an electrically-insulative housing that defines a cavity. The housing has an aperture formed therein that places the cavity in fluid communication with the environment around the first electrical connector. The first electrical connector also comprises a power contact having a mating portion located in the cavity.

The connector system also comprises a second electrical connector that mates with the first electrical connector. The second electrical connector comprises an electrically-insulative housing that defines a cavity. The housing of the second electrical connector has an aperture formed therein that places the cavity of the second electrical connector in fluid communication with the environment around the second electrical connector. The second electrical connector also comprises a power contact having a mating portion located in the cavity of the housing of the second electrical connector.

The apertures formed in the housings of the first and second electrical connectors overlap when the first and second electrical connectors are mated.

Embodiments of electrical connectors for mounting on a substrate comprise a power contact and an electrically insulative housing that receives the power contact. An aperture is formed in the housing. The aperture is aligned with a mating portion of power contact whereby air heated by the power contact can exit the power contact by way of the aperture. A recess is formed in the housing. The recess faces the substrate, and the recess and the substrate define a passage extending from a side portion of the housing when the electrical connector is mounted on the substrate. A portion of the power contact extends through the recess, whereby air from the environment around the electrical connector can pass between the housing and substrate and over the power contact.

Embodiments of electrical connectors comprise an electrically insulative housing, and a power contact mounted in the housing and having a mating portion. The housing has an aperture formed therein and aligned with the mating portion of the contact whereby air heated by the power contact can exit the power contact by way of the aperture.

Embodiments of electrical connectors include a housing and two different types of power contacts. The power contacts include polarizing features that reduce or eliminate the potential for the power contacts to be improperly installed in the housing.

Embodiments of electrical connectors comprise a first power contact comprising a tab; a second power contact comprising a tab; and a housing having a first and a second cavity formed therein that receive the respective first and second power contacts. The tab of the first power contact interferedly contacts the housing when the first power contact is partially inserted into the second cavity thereby preventing installation of the first power contact in the second cavity. The tab of the second power contact interferedly contacts the housing when the second power contact is partially inserted into the first cavity thereby preventing installation of the second power contact in the first cavity.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a top perspective view of a preferred embodiment of a connector system depicting a header connector and a receptacle connector of the connector system in a fully mated condition;

FIG. 2 is a side view of the connector system shown in FIG. 1, depicting the header connector and the receptacle connector in the fully mated condition;

FIG. 3 is a top perspective view of the connector system shown in FIGS. 1 and 2, depicting the header connector and the receptacle connector an unmated condition;

FIG. 4 is a top perspective view of the connector system shown in FIGS. 1-3, depicting the header connector and the receptacle connector the unmated condition;

FIG. 5 is top view of the connector system shown in FIGS. 1-4, depicting the header connector and the receptacle connector in a partially mated condition;

FIG. 6 is a magnified, partial cutaway view of the area designated “A” in FIG. 5;

FIG. 7 is top view of the connector system shown in FIGS. 1-6, depicting the header connector and the receptacle connector in the fully mated condition;

FIG. 8 is a magnified, partial cutaway view of the area designated “B” in FIG. 7;

FIG. 9 is bottom perspective view of the connector system shown in FIGS. 1-8, depicting the header connector and the receptacle connector in the fully mated condition;

FIG. 10 is a magnified view of the area designated “C” in FIG. 9;

FIGS. 11 and 12 are perspective views of a power contact of the header connector shown in FIGS. 1-10;

FIG. 13 is a top perspective view of an alternative embodiment of the connector system shown in FIGS. 1-12, depicting a header connector and a receptacle connector of the connector system in a fully mated condition;

FIG. 14 is a bottom perspective view of the connector system shown in FIG. 13, depicting the header connector and the receptacle connector in the fully mated condition

FIG. 15 is a rear perspective view of a housing of another alternative embodiment of the connector system shown in FIGS. 1-12;

FIGS. 16A and 16B are rear perspective views of a respective long and short power contact of the connector system shown in FIG. 15;

FIG. 17 is rear view of the connector system shown in FIGS. 15-16B, depicting the short and long power contacts correctly installed in associated cavities in the housing;

FIG. 18 is a rear view of the connector system shown in FIGS. 15-17, depicting one of the short and one of the long power contacts incorrectly correctly installed in associated cavities in the housing;

FIG. 19 is a top view of the connector system shown in FIGS. 15-18, depicting one of the short and one of the long power contacts incorrectly correctly installed in associated cavities in the housing;

FIG. 20 is a cross-sectional view of the connector system shown in FIGS. 15-19, taken through the line “D-D” of FIG. 17;

FIG. 21 is a magnified view of the area designated “E” in FIG. 20;

FIGS. 22A and 22B are perspective views of a respective long and short power contact of another alternative embodiment of the connector system shown in FIGS. 1-12;

FIG. 23 a rear view of the connector system shown in FIGS. 15-16B, depicting the short and long power contacts correctly installed in associated cavities in a housing of the connector system; and

FIG. 24 is a rear view of the connector system shown in FIGS. 22A-23, depicting one of the short and one of the long power contacts incorrectly correctly installed in associated cavities in the housing.

### DETAILED DESCRIPTION OF ILLUSTRATIVE EMBODIMENTS

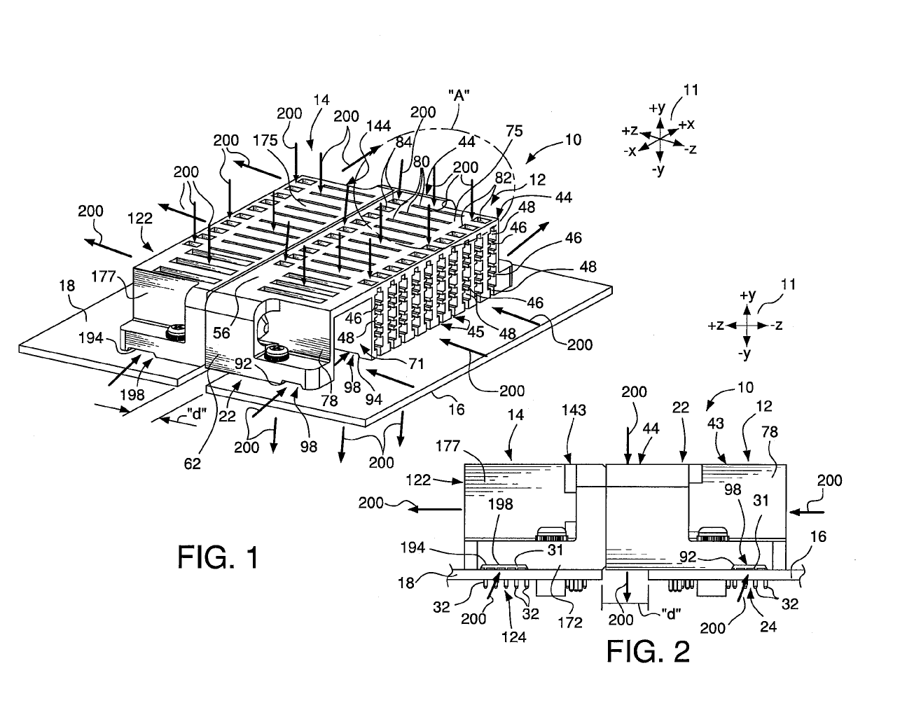

FIGS. 1 through 12 depict an embodiment of a co-planar connector system 10. The figures are referenced to a common coordinate system 11 depicted therein. The connector system 10 comprises a header connector 12, and a receptacle connector 14 that mates with the header connector 12. The header connector 12 can be mounted on a substrate such as a printed circuit board (PCB) 16, and the receptacle connector 14 can be mounted on a substrate such as a PCB 18. The header connector 12 and the receptacle connector 14, when mated, electrically connect the PCB 16 and the PCB 18.

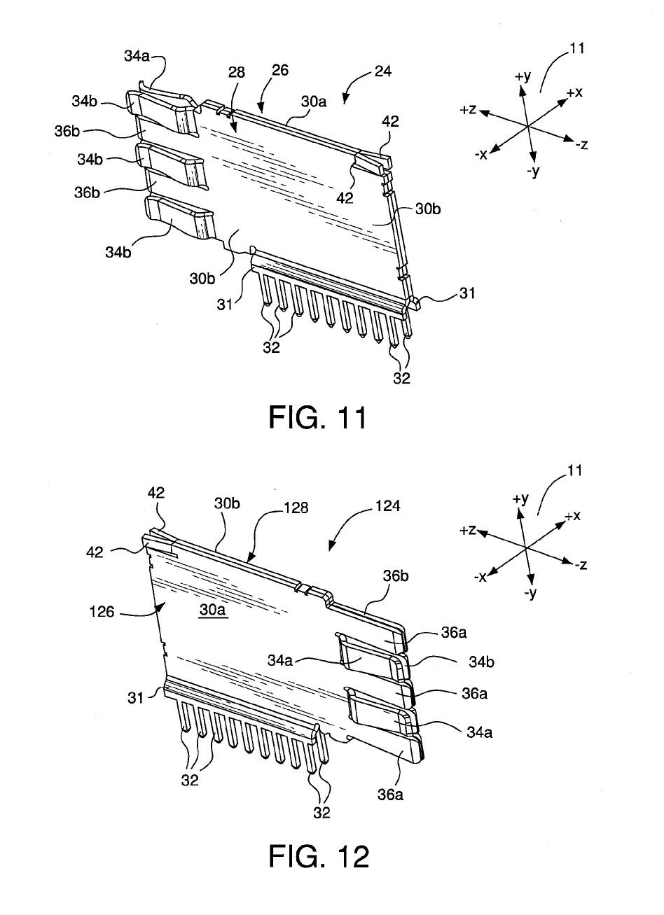

The header connector 12 comprises an electrically insulative housing 22, and a plurality of power contacts 24 mounted in the housing 22. Each power contact 24 comprises a first half 26 and a second half 28, as shown in FIG. 11. The first half 26 includes a plate-like body member 30a, and a substantially S-shaped portion 31 that adjoins a lower end of the body member 30a. The first half 26 also includes a plurality of terminal pins 32 that each extend from a lower end of the S-shaped portion 31.

The first half 26 further includes three angled contact beams 34a and two substantially straight contact beams 36a that each extend from a forward edge of the body member 30a. The angled contact beams 34a and the straight contact beams 36a are arranged on the body member 30a in a staggered manner, i.e., each straight contact beam 36a is positioned adjacent to two of the angled contact beams 34a.

Directional terms such as “upper,” “lower,” “forward,” “rearward,” “top,” “bottom,” “above,” “below,” etc., are used with reference to the component orientations depicted in FIG. 1. These terms are used for exemplary purposes only, and are not intended to limit the scope of the appended claims.

The second half 28 of each power contact 24 includes a plate-like body member 30b, and another S-shaped portion 31 that adjoins a lower end of the body member 30b. The second half 28 also includes a plurality of terminal pins 32 that each extend from a lower end of the S-shaped portion 31.

The second half 28 further includes three angled contact beams 34b and two substantially straight contact beams 36b that each extend from a forward edge of the body member 30b. The angled contact beams 34b and the straight contact beams 36b are arranged on the body member 30b in a staggered manner, as shown in FIG. 11.

The body members 30a, 30b are stacked against each other as shown in FIG. 11, so that each angled contact beam 34a faces, and is spaced apart from an associated angled contact beam 34b; and each straight contact beam 36a faces and abuts an associated contact beam 36b. The S-shaped portions 31 provide an offset between the terminal pins 32 of the first half 26 and the terminal pins 32 of the second half 28 when the body members 30a, 30b are stacked.

Each body member 30a, 30b can include a tab 42 located at an upper rearward corner thereof. The tabs 42 are angled outward, as depicted in FIG. 11. Each tab 42 can contact an associated lip (not shown) on the housing 22 as the power contact 24 is inserted into the housing 22 from the rearward end thereof. Contact between the tab 42 and the lip causes the tab 42 to deflect inward. The tab 42 clears the lip as the power contact 24 approaches its fully-inserted position within the housing 22. The resilience of the tab 42 causes the tab 42 to spring outward, to its original position, once the tab 42 clears the lip. Interference between the tab 42 and the lip can discourage the power contact 24 from backing out of the housing 22.

Specific details of the power contacts 24 are presented for exemplary purposes only. The principles of the present invention can be applied to connectors comprising other types of power contacts, including the power contacts described in the related applications cross-referenced above.

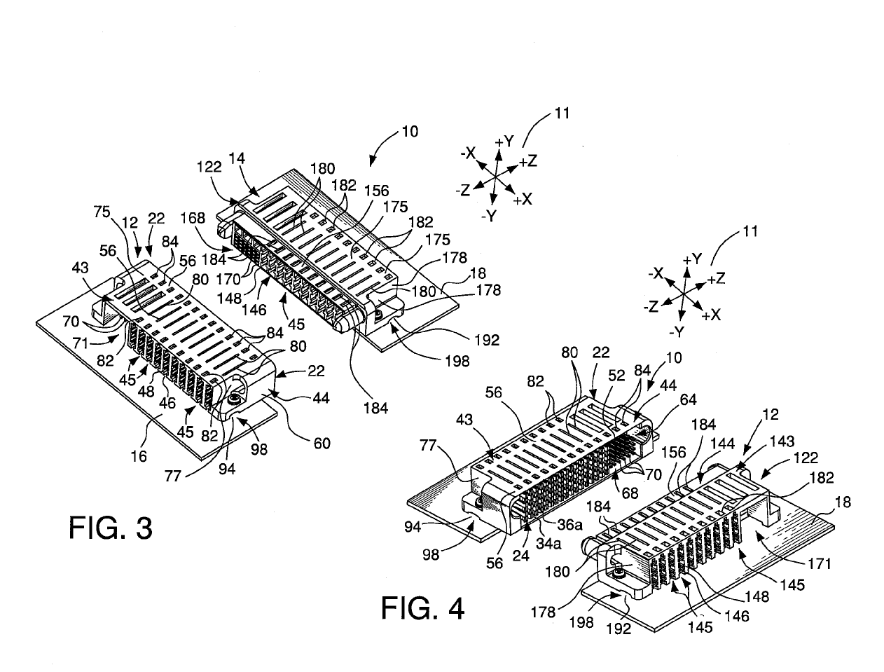

The housing 22 includes a main body 43 and an adjoining mating portion 44, as shown in FIGS. 1 through 4. The main body 43 has a plurality of cavities 45 formed therein, as shown in FIGS. 1 and 3. Each cavity 45 receives the body members 30a, 30b of an associated power contact 24. The cavities 45 are each defined, in part, by ribs 46 of the housing 22. The ribs 46 are arranged in opposing pairs. The ribs 46 contact the body members 30a or 30b of the associated power contact 24 as the power contact 24 is slid into the cavity 45. Interference between the ribs 46 and the body members 30a, 30b pushes the body members 30a, 30b together, and helps to retain the power contact 24 in the cavity 45.

The ribs 46 define grooves 48 therebetween, as depicted in FIGS. 1 and 3. The grooves 48, as discussed below, facilitate heat transfer from the power contacts 24 during operation of the header connector 12.

The main body 43 of the housing 22 includes a forward wall 52. The forward wall 52 is depicted, in part, in FIG. 4. The cavities 45 extend through the forward wall 52, so that the angled contact beams 34a, 34b and the straight contact beams 36a, 36b of the power contacts 24 can pass through the forward wall 52 when the power contacts 24 are inserted into the housing 22 from the rearward end thereof.

The mating portion 44 of the housing 22 includes a top portion 56, a bottom portion 58, and side portions 60, 62, as shown in FIGS. 1-4 and 9. The top portion 56, bottom portion 58, side portions 60, 62, and forward wall 52 define a mating zone or cavity 64, as depicted in FIG. 4. The cavity 64 adjoins the cavities 45 of the main body 43. The mating portion 44 overhangs a forward edge of the PCB 16 when the header connector 12 is mounted thereon, as shown in FIGS. 1 through 4 and 9.

The angled contact beams 34a, 34b and the straight contact beams 36a, 36b of the power contact 24 extend into the cavity 64, as depicted in FIG. 4. The cavity 64, as discussed below, receives a portion of the receptacle connector 14 when the header and receptacle connectors 12, 14 are mated.

The header connector 12 can include an array 68 of signal contacts 70. The array 68 can be located to one side of the power contacts 24, as shown in FIG. 4. A portion of the array 70 can be positioned in a cavity 71 formed in the housing 22, as shown in FIG. 3. The array 70 can be located at or near the center of the header connector 12, between the power contacts 24, in alternative embodiments of the header connector 12. Other alternative embodiments can forgo the use of any signal contacts 70.

The main body 43 of the housing 22 has a top portion 75, a bottom portion 76, and side portions 77, 78, as shown in FIGS. 1-4. A plurality of elongated slots or apertures 80 are preferably formed in the top portion 75, as shown in FIGS. 1, 3, 4, 5, and 7. Each aperture 80 is located above the body portions 30a, 30b of the associated power contacts 24. The apertures 80 extend in the widthwise, or “z” direction of the housing 22.

The apertures 80 each adjoin an associated cavity 45, and thereby place the cavity 45 in fluid communication with the environment around the header connector 12. Preferably, the width, or “x” dimension of each aperture 80 is as large as, or greater than the combined width, or “x” dimension, of the body portions 30a, 30b of the associated power contact 24.

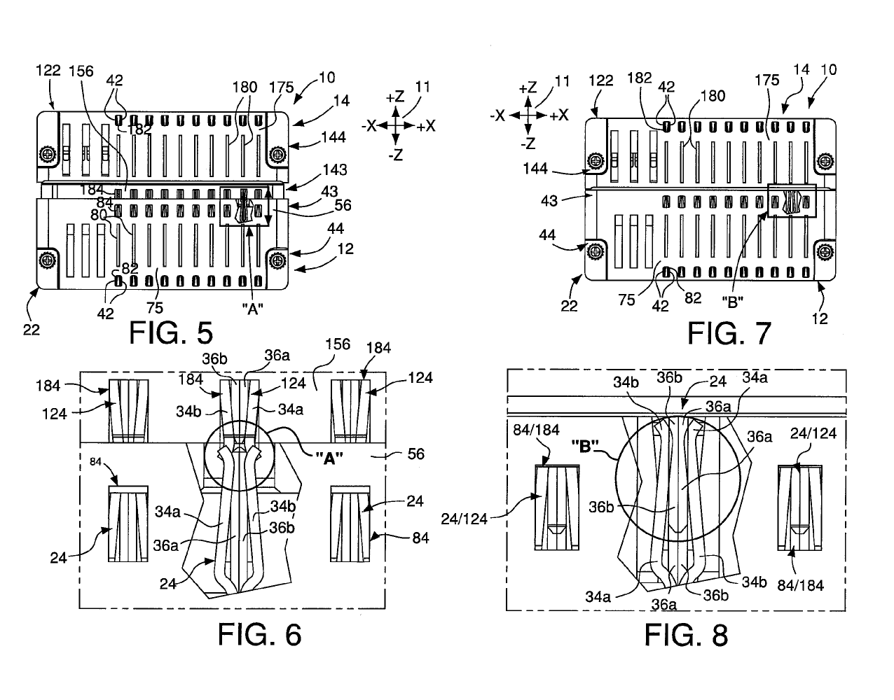

Additional apertures 82 are preferably formed in the top portion 75 of the main body 43, proximate the rearward end thereof, as shown in FIGS. 1, 3, 4, 5, and 7. Each aperture 82 adjoins an associated cavity 45 and is located above the tabs 42 of the associated power contact 24, as shown in FIGS. 5 and 7. The apertures 82 place the rearward ends of the cavities 45 in fluid communication with the environment around the header connector 12. Preferably, the width, or “x” dimension of each aperture 82 is about equal to, or greater than the tip-to-tip width of the tabs 42 of the associated power contact 24.

Apertures 84 are preferably formed in the top portion 56 of the mating portion 44, as shown in FIGS. 1 and 3-8. The apertures 84 adjoin the cavity 64. Each aperture 84 is located above the angled contact beams 34a, 34b and the straight contact beams 36a, 36b of an associated power contact 24, i.e., each aperture 84 is aligned with the angled contact beams 34a, 34b and the straight contact beams 36a, 36b of the associated power contact 24 in the “y” direction, as shown in FIGS. 6 and 8.

The apertures 84 place the cavity 64 fluid communication with the environment around the header connector 12. Preferably, the width, or “x” dimension of each aperture 84 is as large as, or greater than the combined width of the straight contact beams 36a, 36b of the associated power contact 24, as shown in FIGS. 6 and 8.

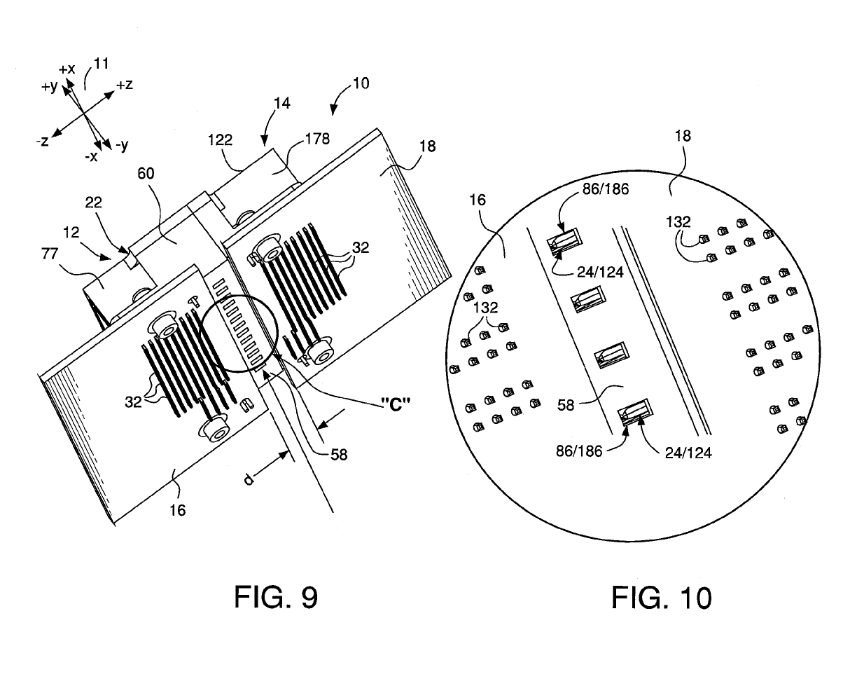

Apertures 86 are preferably formed in the bottom portion 58 of the mating portion 44, as shown in FIGS. 9 and 10. The apertures 86 adjoin the cavity 64, and are substantially similar to the apertures 84. Each aperture 86 is located below the angled contact beams 34a, 34b and the straight contact beams 36a, 36b of the associated power contact 24, i.e., each aperture 86 is aligned with the angled contact beams 34a, 34b and the straight contact beams 36a, 36b of the associated power contact 24 in the “y” direction, as shown in FIG. 10. The apertures 86 place the cavity 64 fluid communication with the environment around the header connector 12.

A recess 92 is preferably formed in the bottom portion 76 of the main body 43 of the housing 22, as shown in FIGS. 1 and 2. The recess 92 extends substantially in the lengthwise, or “x” direction of the housing 22, between the side portion 78 and the cavity 71. Another recess 94 is preferably formed in the bottom portion 76, between the side portion 77 and the cavity 71, as shown in FIGS. 3 and 4. The recess 94 substantially aligns with the recess 92 in the “x” direction.

The recesses 92, 94 each face the PCB 16 when the header connector 12 is mounted thereon. The recesses 92, 94, the cavity 71, and the PCB 16 define a passage 98 that extends across the entire length, or “x” dimension of the housing 22.

The receptacle connector 14 comprises an electrically insulative housing 122, and a plurality of power contacts 124 mounted in the housing 122. The power contacts 124 are configured to mate with the power contacts 24 of the header connector 12.

Each power contact 124 includes a first half 126 and a second half 128, as shown in FIG. 12. The power contacts 124 are substantially identical to the power contacts 24, with the exception that the first and second halves 126, 128 each include two of the angled contact beams 34a and three of the substantially straight contact beams 36a. Portions of the power contacts 124 that are substantially identical to those of the power contacts 24 are denoted in the figures by identical reference numerals.

The angled contact beams 34a and the straight contact beams 36a of the first half 126 are arranged on the body member 30a of the first half 126 in a staggered manner, i.e., each angled contact beam 36a is positioned adjacent to two of the straight contact beams 34a, as shown in FIG. 12. The angled contact beams 34b and the straight contact beams 36b likewise are arranged on the body member 30b of the second half 128 in a staggered manner.

The housing 122 of the receptacle connector 14 includes a main body 143 and an adjoining mating portion 144, as shown in FIGS. 3 and 4. The mating portion 144, as discussed below, is received within the cavity 64 of the header connector 12 when the header and receptacle connectors 12, 14 are mated.

The housing 122 has a plurality of cavities 145 formed therein, as shown in FIG. 4. The cavities 145 each extend through the main body 143 and the mating portion 144, between the forward and rearward ends the housing 122. Each cavity 145 receives the body members 30a, 30b, the angled contact beams 34a, 34b, and the straight contact beams 36a, 36b of an associated power contact 124. The angled contact beams 34a, 34b, and the straight contact beams 36a, 36b of each power contact 124 reside within the mating portion 144 when the power contact 124 is inserted in the housing 122.

Each cavity 145 is defined, in part, by ribs 146 of the housing 122. The ribs 146 are arranged in opposing pairs, as shown in FIG. 4. The ribs 146 contact the body members 30a or 30b of the associated power contact 124 as the power contact 124 is slid into the cavity 145. Interference between the ribs 146 and the body members 30a, 30b pushes the body members 30a, 30b together, and helps to retain the power contact 124 in the cavity 145.

The ribs 146 define grooves 148 therebetween. The grooves 148, as discussed below, facilitate heat transfer from the power contacts 124 during operation of the receptacle connector 14.

The receptacle connector 14 can include an array 168 of signal contacts 170, as shown in FIG. 3. The array 168 can be located to one side of the power contacts 124, as shown in FIG. 3. A portion of the array 168 can be positioned in a cavity 171 formed in the housing 122, as shown in FIG. 4. The array 168 can be located at or near the center of the receptacle connector 14, between the power contacts 124, in alternative embodiments of the receptacle connector 14. Other alternative embodiments can forgo the use of any signal contacts 170.

The main body 143 of the housing 122 has a top portion 175, a bottom portion 176, and side portions 177, 178, as shown in FIGS. 1-4. A plurality of elongated slots or apertures 180 are preferably formed in the top portion 175, as shown in FIGS. 1, 3, 4, 5, and 7. Each aperture 180 is located above the body portions 30a, 30b of the associated power contacts 124. The apertures 180 extend in the widthwise, or “z” direction of the housing 124. The apertures 180 each adjoin an associated cavity 145, and thereby place the cavity 145 in fluid communication with the environment around the receptacle connector 14. Preferably, the width, or “x” dimension of each aperture 180 is as large as, or greater than the combined width, or “x” dimension, of the body portions 30a, 30b of the associated power contact 124.

Additional apertures 182 are preferably formed in the top portion 175 of the main body 143, proximate the rearward end thereof. Each aperture 182 adjoins an associated cavity 145 and is located above the tabs 42 of the associated power contact 124, as shown in FIGS. 5 and 7. The apertures 182 place the rearward ends of the cavities 145 in fluid communication with the environment around the receptacle connector 14. The width, or “x” dimension of each aperture 182 is preferably about equal to, or greater than the tip-to-tip width of the tabs 42 of the associated power contact 124, as shown in FIGS. 5 and 7.

The mating portion 144 of the housing 122 overhangs a forward edge of the PCB 18 when the receptacle connector 14 is mounted thereon, as shown in FIGS. 3 and 4. The mating portion 144 has a top portion 156 and a bottom portion (not shown). Apertures 184 are preferably formed in the top portion 156, as shown in FIGS. 3-8. The apertures 184 each adjoin the forward end of an associated cavity 145. Each aperture 184 is located above the angled contact beams 34a, 34b and the straight contact beams 36a, 36b of an associated power contact 124, i.e., each aperture 84 is aligned with the angled contact beams 34a, 34b and the straight contact beams 36a, 36b of the associated power contact 124 in the “y” direction, as shown in FIGS. 5 and 6.

The apertures 184 place the associated cavity 145 in fluid communication with the environment around the receptacle connector 14. Preferably, the width, or “x” dimension of each aperture 184 is as large as, or greater than the combined width of the straight contact beams 36a, 36b of the associated power contact 124, as shown in FIG. 6.

Apertures 186 are preferably formed in the bottom portion of the mating portion 144, as shown in FIG. 10. The apertures 186 each adjoin the forward end of an associated cavity 145, and are substantially similar to the apertures 184. Each aperture 186 is located below the angled contact beams 34a, 34b and the straight contact beams 36a, 36b of the associated power contact 124, i.e., each aperture 186 is aligned with the angled contact beams 34a, 34b and the straight contact beams 36a, 36b of the associated power contact 124 in the “y” direction, as shown in FIG. 10. Each aperture 186 places the associated cavity 145 in fluid communication with the environment around the receptacle connector 14.

A recess 192 is preferably formed in the bottom portion 176 of the main body 143 of the housing 122, as shown in FIGS. 3 and 4. The recess 192 extends substantially in the lengthwise, or “x” direction of the housing 122, between the side portion 178 and the cavity 171. Another recess 194 is preferably formed in the bottom portion 176, between the side portion 177 and the cavity 171, as shown in FIGS. 1 and 2. The recess 194 substantially aligns with the recess 192 in the “x” direction.

The recesses 192, 194 each face the PCB 18 when the receptacle connector 14 is mounted thereon. The recesses 192, 194, the cavity 171, and the PCB 18 define a passage 198 that extends across the entire length, or “x” dimension of the housing 122.

The plug and receptacle connectors 12, 14 are mated by aligning the mating portion 144 of the receptacle connector 14 with the cavity 64 of the plug connector 12. One or both of the plug and receptacle connectors 12, 14 are then moved toward each other, until the mating portion 144 begins to enter the cavity 64. Further movement of the plug and receptacle connectors 12, 14 toward each other causes each of the angled contact beams 34a, 34b and the straight contact beams 36a, 36b of the power contacts 24 of the plug connector 12 to enter an associated cavity 145 of the housing 122 of the receptacle connector 14.

Each associated pair of straight contact beams 36a, 36b of the power contact 24 subsequently enters the space between an associated pair of the angled contact beams 34a, 34b of the power contact 124, as shown in FIGS. 5 and 6. Contact between the straight contact beams 36a, 36b and the angled contact beams 34a, 34b causes the angled contact beams 36a, 36b to resiliently deflect in an outward direction, i.e., in a direction away from the straight contact beams 34a, 34b. The resilient deflection of the angled contact beams 34a, 34b of the power contact 124 results in a contact force between the angled contact beams 34a, 34b of the power contact 124 and the straight contact beams 36a, 36b of the power contact 24.

Each associated pair of straight contact beams 36a, 36b of the power contact 124 likewise enters the space between an associated pair of the angled contact beams 34a, 34b of the power contact 24. The resulting deflection of the angled contact beams 34a, 34b of the power contact 24 results in a contact force between the angled contact beams 34a, 34b of the power contact 124 and the straight contact beams 36a, 36b of the power contact 124.

The forward edges of the PCB 16 and the PCB 18 are spaced apart by a gap when the plug and receptacle connectors 12, 14 are fully mated. This gap is denoted by the reference character “d” in FIGS. 1, 2, and 9.

The apertures 84 of the housing 22 and the apertures 184 of the housing 122 are positioned so that each aperture 84 overlaps, or substantially aligns with corresponding aperture 184 when the header and receptacle connectors 12, 14 are fully mated, as shown in FIG. 8.

The apertures 86 of the housing 22 and the apertures 186 of the housing 122 likewise are positioned so that each aperture 86 overlaps, or substantially aligns with corresponding aperture 186 when the header and receptacle connectors 12, 14 are fully mated, as shown in FIG. 10.

The apertures 84, 86, 184, 186 facilitate air circulation through the housings 22, 122 and over the power contacts 24, 124. This air circulation can help to cool the power contacts 24, 124 during operation.

For example, FIGS. 1 and 2 include arrows 200 designating one possible manner in which air can circulate through the header and receptacle connectors 12, 14. In this particular scenario, one or more cooling fans (not shown) are used to direct air downward and over the header and receptacle connectors 12, 14. The overlapping apertures 84, 184 permit the relatively cool, downwardly-flowing air to enter the mating portions 44, 144 of the respective housings 22, 122. The air entering the mating portions 44, 144 can displace the air within the mating portions 44, 144, which has been heated by the angled contact beams 34a, 34a and the straight contact beams 36a, 36b of the relatively warm power contacts 24, 124.

The lower apertures 86, 186 can permit the heated air that has been displaced within the mating portions 44, 144 by the cooler incoming air to exit the mating portions 44, 144. The gap “d” between the PCBs 16, 18 permits the air exiting the mating portions 44, 144 to flow freely into the environment around the header and receptacle connectors 12, 14.

Heat energy is transferred to the relatively cool air from the angled contact beams 34a, 34b and the straight contact beams 36a, 36b, as the air is forced downward and over the angled contact beams 34a, 34b and the straight contact beams 36a, 36b. This convective heat transfer cools the angled contact beams 34a, 34b and the straight contact beams 36a, 36b, while heating the air. The heated air, in turn, is forced downward and through the overlapping lower apertures 86, 186, giving rise to an air-circulation pattern within the mating portions 44, 144. This circulation dissipates heat energy from the power contacts 24, 124, and thereby cools the power contacts 24, 124.

The apertures 80, 180 also facilitate cooling of the respective power contacts 24, 124 during operation. In particular, the apertures 80, 180 permit the relatively cool air being forced downward over the header and receptacle connectors 12, 14 to impinge upon the top of each body portion 30a, 30b of the power contacts 24, 124. The impingement of the relatively cool air on the body portions 30a, 30b helps to dissipate heat energy from the power contacts 24, 124.

The apertures 82, 182 likewise facilitate cooling of the respective power contacts 24, 124. In particular, the apertures 82, 182 permit the relatively cool air being forced downward over the header and receptacle connectors 12, 14 to impinge upon the top of each tab 42 of the power contacts 24, 124. The impingement of the relatively cool air on the tabs 42 helps to dissipate heat energy from the power contacts 24, 124.

The grooves 48, 148 of the respective housings 22, 122 are configured so that each groove 48 substantially aligns with an associated groove 148 when the header and receptacle connectors 12, 24 are mated. This arrangement can facilitate cooling of the power contacts 24, 124. For example, relatively cool air can be forced over the header and receptacle connectors 12, 14 in the “z” direction, as denoted in FIGS. 1 and 2, by one or more additional cooling fans. The cooling air can enter the rearward ends of the grooves 48. As each groove 48 substantially aligns with a corresponding groove 148 in the housing 122, the cooling air can travel the entire combined width, or “z” dimension, of the header and receptacle connectors 12, 14, and can exit the housing 22 by way of the distal ends of the grooves 148.

The cool air being forced through the grooves 48, 148 passes over the relatively warm body portions 30a, 30b of the power contacts 24, 124. The air dissipates heat energy from the body portions 30a, 30b through convective heat transfer, and thereby cools the power contacts 24, 124.

The recesses 92, 94 and the cavity 71 formed in the housing 22, and the PCB 16 define a passage 98, as discussed above. The passage 98 can facilitate cooling of the power contacts 24. In particular, relatively cool air can be forced into and through the passage 98 in the “x” direction, as denoted in FIG. 1, by one or more additional cooling fans. The S-shaped portions 31 and the adjoining terminal pins 32 of the power contacts 24 are partially located within the passage 98, as shown in FIG. 2. The air flowing through the passage 98 can flow over and under the S-shaped portions 31, and between the terminal pins 31. The relatively cool air dissipates heat energy from the power contacts 24 through convective heat transfer, thereby cooling the power contacts 24.

The recesses 192, 194 and the cavity 171 formed in the housing 122, and the PCB 18 define a passage 198, as discussed above. The passage 198 can facilitate cooling of the power contacts 124 of the receptacle connector 14, in the manner discussed above in relation to the passage 98.

The above described air-circulation features of the header and receptacle contacts 12, 14 facilitate three-dimensional circulation of cooling air within the header and receptacle contacts 12, 14. The cooling of the power contacts 24, 124 facilitated by these features can permit the power contacts 24, 124 to operate at higher currents than would otherwise be possible. In particular, the maximum current rating of power contacts 24, 124 may be limited by the maximum acceptable temperature rise in the power contacts 24, 124. The heat dissipation facilitated by some or all of the above-described air-circulation features can permit the power contacts 24, 124 to operate at a higher current, with the same temperature rise as experienced in an application where the power contacts 24, 124 are not cooled. Thus, the maximum rated current of the power contacts 24, 124 can be increased without substantially increasing the temperature rise therein.

The above-described airflow patterns, and the airflow patterns denoted in the figures are presented for illustrative purposes only. The airflow patterns through and around the header and receptacle connectors 12, 14 can be more complex that the patterns described and illustrated herein. Moreover, the airflow patterns can change when the orientations of the header and receptacle connectors 12, 14 are different than those denoted in the figures.

Different airflow patterns can be created by directing the cooling air at the header and receptacle connectors 12, 14 from directions other than those described herein. Also, the header and receptacle connectors 12, 14 can be operated without forced-air cooling; heat dissipation in this type of application can be achieved primarily through natural convection.

The foregoing description is provided for the purpose of explanation and is not to be construed as limiting the invention. Although the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

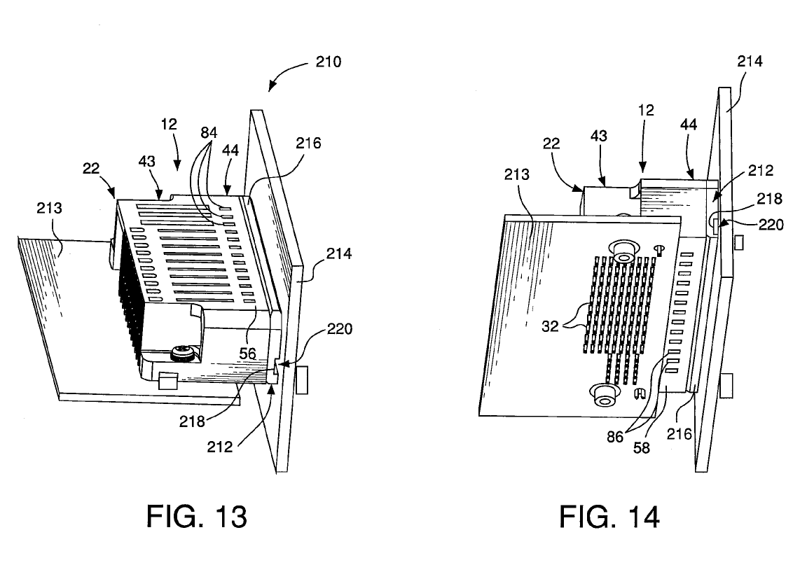

For example, FIGS. 13 and 14 depict an alternative embodiment in the form of a connector system 210. The connector system 210 is configured for use as a backplane connector system. The connector system 210 can include the header connector 12 described above in relation to the connector system 10. The connector system 210 can also include a vertical receptacle connector 212 that mates with the header connector 12. The header connector 12 can be mounted on a daughter card 213. The receptacle connector 212 can be mounted on a motherboard 214 that is oriented substantially perpendicular to the daughter card 213.

The receptacle connector 212 can have features substantially similar or identical to those described above in relation to the receptacle connector 14 for facilitating air circulation through and around the receptacle connector 212. For example, the receptacle connector 212 can have a housing 216 with a mating portion (not shown) that is received by the mating portion 43 of the header connector 12 when the header and receptacle connectors 12, 212 are mated. The mating portion of the housing 216 can have apertures formed in top and bottom potions thereof. The apertures can align with the apertures 84, 184 formed in the mating portion 44 of the header connector 12.

The housing 216 of the receptacle connector 212 can have one or more recesses 218 formed therein. The recesses 218 and the motherboard 214 can define a passage 220 that facilitates air circulation between the housing 216 and the motherboard 214, in the manner discussed above in relation to the passage 198 defined by the receptacle connector 14 and the PCB 18.

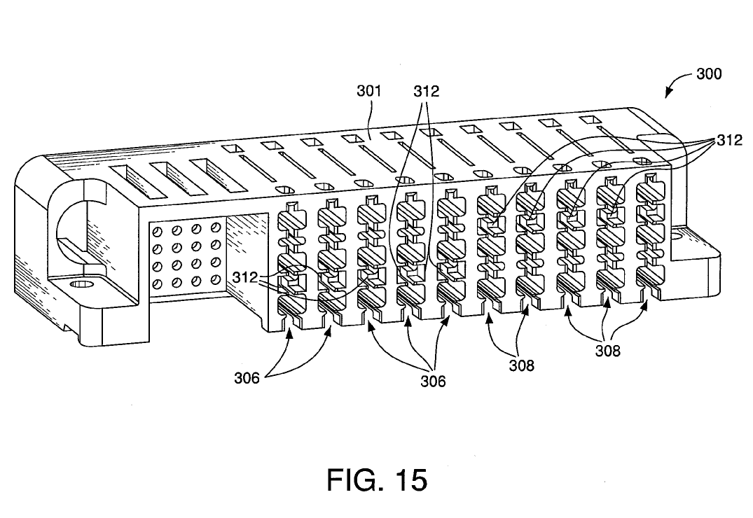

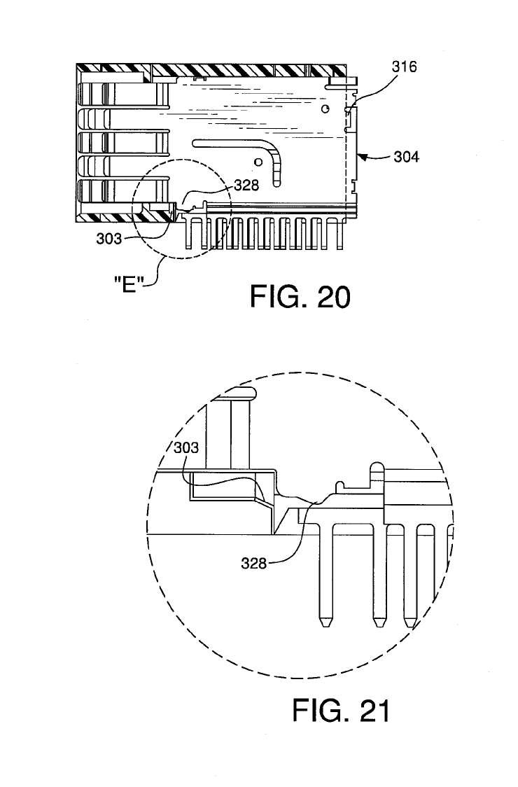

FIGS. 15-21 depict an alternative embodiment of the header connector 12 in the form of a header connector 300. The header connector 300, except where otherwise noted, can be substantially similar or identical to the header connector 12.

The header connector 300 includes a housing 301, short power contacts 302, and long power contacts 304. The short power contacts 302 are received in cavities 306 formed in the housing 301. The long power contacts 304 are received in cavities 308 formed in the housing 301.

The housing 301, the short power contacts 302, and the long power contacts 304 include polarizing features that prevent the short power contacts 302 from being inserted into the cavities 308, or the long power contacts 304 from being inserted into the cavities 306. In particular, each cavity 306, 308 has a window 312 formed therein. The window 312 associated with each cavity 306 is located proximate a lower end of the cavity 306, as shown in FIGS. 15, 17, and 18. The window 312 associated with each cavity 308 is located proximate an upper end of the cavity 306.

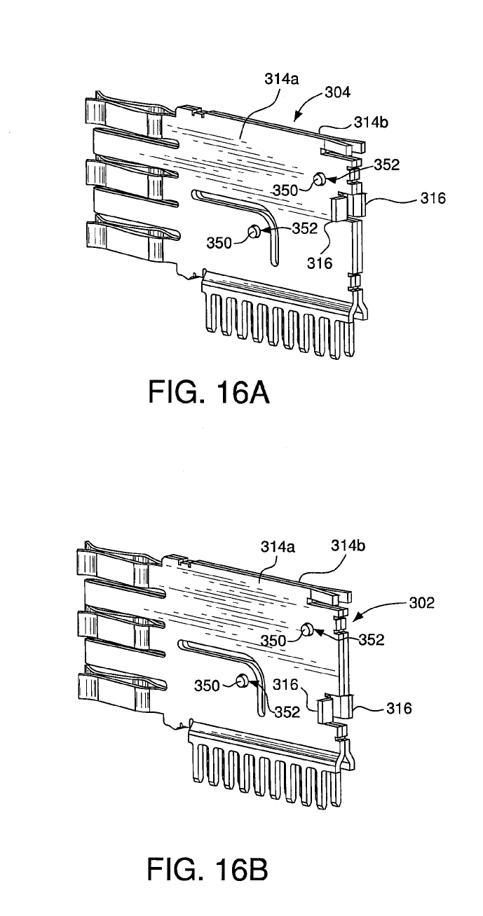

The short and long power contacts 302, 304 each include body members 314a, 314b, as shown in FIGS. 16A and 16B. The short and long power contacts 302, 304 also include tabs 316 located proximate the rearward edges of each body member 314a, 314b. The tabs 316 extend in directions substantially perpendicular to the major surfaces of the body members 314a, 314b. The tabs 316 of each short power contact 302 are located proximate a lower end of the short power contact 302. The tabs 316 of each long power contact 304 are located proximate an upper end of the long power contact 304.

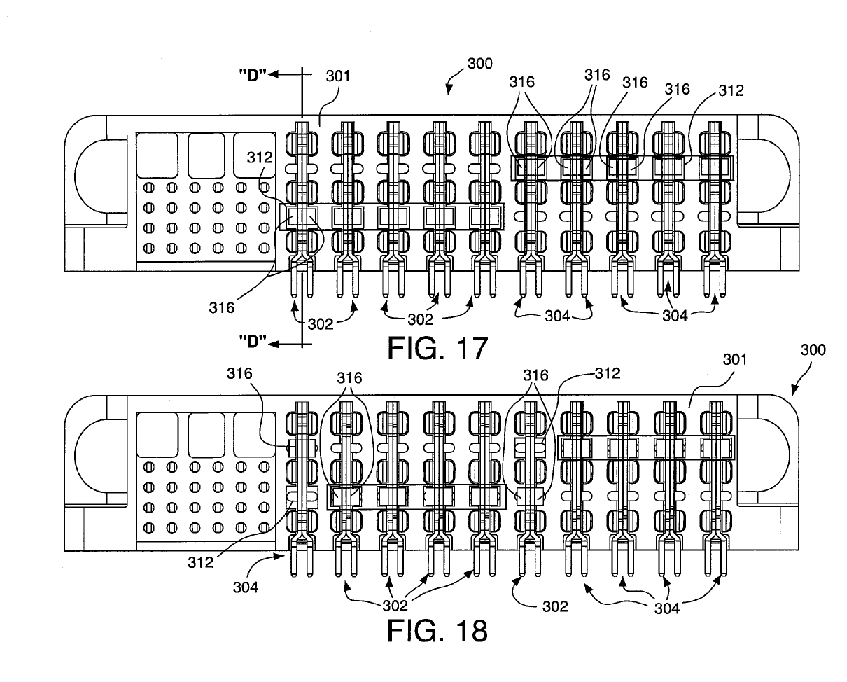

The tabs 316 are sized to fit within the windows 312 of the housing 301. The windows 312 associated with the cavities 306, and the tabs 316 of each short power contact 302 are positioned so that the tabs 316 of the short power contacts 302 each align with, and are received by an associated one of the windows 312 of the cavities 306 when the short power contacts 302 are inserted into the cavities 306, as shown in FIG. 17.

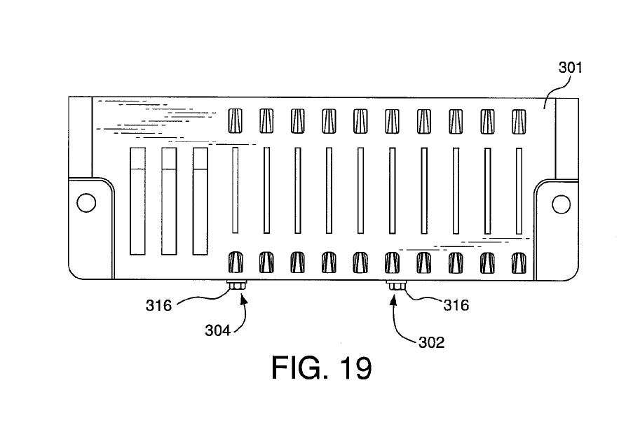

The tabs 316 of the short power contacts 302 do not align with the windows 312 associated with the cavities 308 when an attempt is made to insert one of the short power contacts 302 into one of the cavities 308. Rather, interference between the tabs 316 and the housing 301 prevents the short power contact 302 from advancing into the cavity 308, as shown in FIGS. 18 and 19.

The windows 312 associated with the cavities 308, and the tabs 316 of each long power contact 304 likewise are positioned so that the tabs 316 of the long power contacts 304 align with, and are received by the windows 312 of the cavities 308 when the long power contacts 304 are inserted into the cavities 308, as shown in FIG. 17.

The tabs 316 of the long power contacts 304 do not align with the windows 312 associated with the cavities 306 when an attempt is made to insert one of the long power contacts 304 into one of the cavities 306. Rather, interference between the tabs 316 and the housing 301 prevents the long power contact 304 from advancing into the cavity 306, as shown in FIGS. 18 and 19.

The body members 314a, 314b of the short and long power contacts 302, 304 each include a tab 328, as shown in FIGS. 16A, 16B, 20, and 21. The tabs 328 interferedly engage the housing 301 when the short and long power contacts 302, 304 are fully inserted into the housing 301. Interference between the tabs 328 and the housing 301 helps to retain the short and long power contacts 302, 304 in the housing 301. The housing 301 includes a ramp 303 that helps to guide the tabs 328 into their final positions as the body members 314a, 314b are inserted into the housing 301.

The above-noted noted interference between the tabs 316 of the long power contacts 304 and the housing 301 when the long power contacts 304 are inadvertently installed in the cavities 306 can prevent the long power contacts 304 from advancing far enough into the cavities 306 for the associated tabs 328 to interferedly engage the associated ramps 303 of the housing 301. The above-noted noted interference between the tabs 316 of the short power contacts 302 and the housing 301 when the short power contacts 302 are inadvertently installed in the cavities 308 can likewise prevent the short power contacts 302 from advancing far enough into the cavities 308 for the associated tabs 328 to interferedly engage in the associated ramps 303.

The second half 314b of each short and long power contact 302, 304 can include two cylindrical projections 350, as shown in FIGS. 16A and 16B. The first half 314a of each short and long power contact 302, 304 can include two circular holes 352 that each receive one of the projections 350. The relative positions of the two sets of projections 350 and holes 352 on the short power contacts 302 can differ from the relative locations of the two sets of projections 350 and holes 352 on the long power contacts 304. The projections 350 and holes 352 can thus act as polarizing features that prevent the first half of a short power contact 302 from being inadvertently mated with the second half of a long power contact 304, and vice versa.

The projections 350 and holes 352 can have respective shapes other than cylindrical and circular in alternative embodiments. Moreover, the projections 350 and the holes 352 can be located on the first and second halves 323a, 323b, respectively, of the short and long power contacts 302, 304 in alternative embodiments.

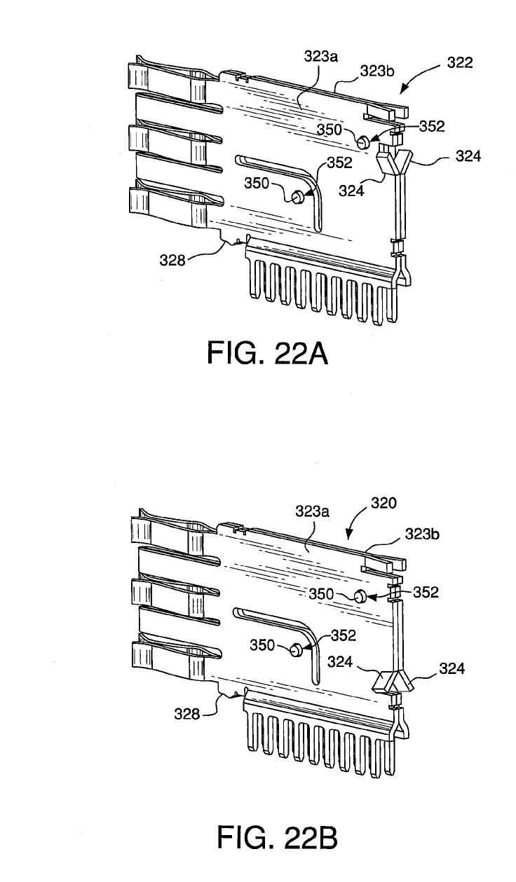

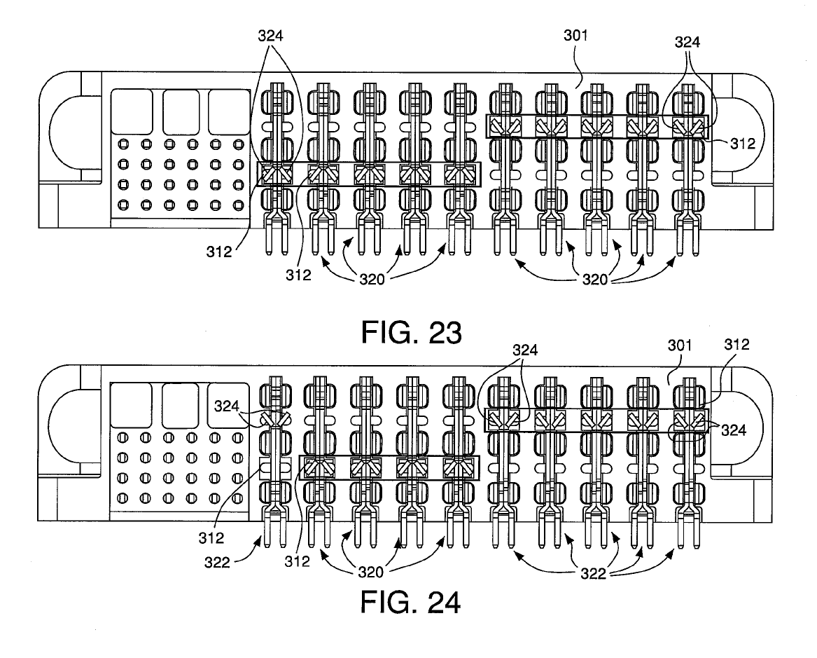

FIGS. 22A through 24 depict alternative embodiments of the short and long power contacts 302, 304 in the form of a short power contact 320 and a long power contact 322. The short and long power contacts 320, 322 are substantially similar to the respective short and long power contacts 302, 304 from a structural and functional perspective, with the exception that the short and long power contacts 320, 322 include tabs 324 that angle outwardly and downwardly from the associated body members 323a, 323b of the short and long power contacts 320, 322.

What is claimed:

1. A connector system, comprising:
a first electrical connector comprising: an electrically-insulative housing that defines a cavity, the housing having an aperture formed therein that places the cavity in fluid communication with the environment around the first electrical connector; and a power contact having a mating portion located in the cavity; and
a second electrical connector that mates with the first electrical connector, the second electrical connector comprising an electrically-insulative housing that defines a cavity, the housing of the second electrical connector having an aperture formed therein that places the cavity of the second electrical connector in fluid communication with the environment around the second electrical connector; and a power contact having a mating portion located in the cavity of the housing of the second electrical connector; wherein the apertures formed in the housings of the first and second electrical connectors overlap when the first and second electrical connectors are mated.

2. The connector system of claim 1, wherein:
the aperture of the housing of the first electrical connector is formed in a top portion of the housing of the first electrical connector;
the housing of the first electrical connector has a second aperture formed in a bottom portion thereof;
the aperture of the housing of the second electrical connector is formed in a top portion of the housing of the second electrical connector;
the housing of the second electrical connector has a second aperture formed in a bottom portion thereof; and
the second apertures of the housings of the first and second electrical connectors overlap when the first and second electrical connectors are mated.

3. The connector system of claim 1, wherein the housing of the second electrical connector has a mating portion that is received by the cavity of the housing of the first electrical connector when the first and second electrical connectors are mated, and the aperture formed in the housing of the second electrical connector is formed in the mating portion of the housing of the second electrical connector.

4. The connector system of claim 1, wherein the aperture formed in the housing of the first electrical connector is aligned with the mating portion of the power contact of the first electrical connector; and the aperture formed in the housing of the second electrical connector is aligned with the mating portion of the power contact of the second electrical connector.

5. The connector system of claim 1, wherein the mating portions of the power contacts of the first and second electrical connectors each comprise a plurality of contact beams.

6. The connector system of claim 1, wherein the housing of the first electrical connector has a recess formed in a bottom portion thereof, the recess extends from a side portion of the housing of the first electrical connector, and the power contact of the first electrical connector extends through the recess.

7. The connector system of claim 6, wherein the first electrical connector can be mounted on a substrate, and the recess and the substrate define a passage that facilitates circulation of air between the housing of the first electrical connector and the substrate and over the power contact of the first electrical connector when the first electrical connector is mounted on the substrate.

8. The connector system of claim 1, wherein:
the power contact of the first electrical connector further comprises a body member electrically and mechanically connected to the mating portion of the power contact of the first electrical connector;
the housing of the first electrical connector has another cavity formed therein that houses the body member and is in fluid communication with the environment around the first electrical connector;
the cavity of the housing of the second electrical connector is in fluid communication with the environment around the first electrical connector; and
the cavities of the housings of the first and second electrical connectors are substantially aligned whereby air can circulate between the cavities.

9. An electrical connector for mounting on a substrate, the electrical connector comprising a power contact and an electrically insulative housing that receives the power contact, wherein: an aperture is formed in the housing; the aperture is aligned with a mating portion of power contact whereby air heated by the power contact can exit the power contact by way of the aperture; a recess is formed in the housing; the recess faces the substrate and the recess and the substrate define a passage extending from a side portion of the housing when the electrical connector is mounted on the substrate; and a portion of the power contact extends through the recess; whereby air from the environment around the electrical connector can pass between the housing and substrate and over the power contact.

10. The connector of claim 9, wherein the power contact comprises a plurality of contact beams and the aperture is aligned with the contact beams.

11. The connector of claim 10, wherein the contact beams are located in a cavity defined by the housing and the aperture places the cavity in fluid communication with the environment around the electrical connector.

12. The connector of claim 9, wherein the power contact comprises a terminal pin that engages the substrate, and a portion of the terminal pin is located within the recess formed in the bottom portion of the housing.

13. The connector of claim 12, wherein the power contact further comprises a plate-like body member and a substantially S-shaped portion that adjoins the body member and the terminal pin, wherein the a portion of the S-shaped portion is located within the recess.

14. The connector of claim 11, wherein the aperture is located above the contact beams, and another aperture is formed in the housing below the contact beams whereby air can circulate through the cavity and over the contact beams by way of the apertures.

15. The connector of claim 11, wherein the aperture facilitates air circulation in a first direction, and the recess facilitates air circulation in a second direction substantially perpendicular to the first direction.

16. The connector of claim 15, wherein an end of the cavity is in fluid communication with the environment around the electrical connector, and the cavity extends substantially in a third direction substantially perpendicular to the first and second directions whereby the cavity facilitates air circulation in the third direction.

17. The connector of claim 9, wherein a second aperture is formed in the housing and is aligned with the other aperture and the mating portion of power contact, whereby air heated by the power contact can circulate over the mating portion of the power contact by way of the apertures.

18. An electrical connector, comprising:
an electrically insulative housing; and
a power contact mounted in the housing and having a mating portion, wherein the housing has an aperture formed therein and aligned with the mating portion of the contact whereby air heated by the power contact can exit the power contact by way of the aperture.

19. The electrical connector of claim 18, wherein the housing has a top portion having the aperture formed therein, and a bottom portion having another aperture formed therein and aligned with the mating portion of the contact.

20. The electrical connector of claim 19, wherein the bottom portion of the housing has a recess formed therein, and the power contact extends through the recess.

21. An electrical connector, comprising:
a first power contact comprising a tab;
a second power contact comprising a tab; and
a housing having a first and a second cavity formed therein that receive the respective first and second power contacts, wherein the tab of the first power contact interferedly contacts the housing when the first power contact is partially inserted into the second cavity thereby preventing installation of the first power contact in the second cavity, and the tab of the second power contact interferedly contacts the housing when the second power contact is partially inserted into the first cavity thereby preventing installation of the second power contact in the first cavity.

22. The electrical connector of claim 21, wherein the first cavity includes a window that receives the tab of the first power contact, and the second cavity includes a window that receives the tab of the second power contact.

23. The electrical connector of claim 22, wherein the window of the first cavity and the tab of the second power contact are misaligned when the second power contact is partially inserted into the first cavity; and the window of the second cavity and the tab of the first power contact are misaligned when the first power contact is partially inserted into the second cavity.

24. The electrical connector of claim 21, wherein:
the first power contact includes a first and a second half, the first half having a first and a second projection formed thereon, and the second half having a first and a second hole formed therein that each receive an associated one of the projections when the first half is stacked against the second half, the projections being spaced apart on the first half by a first distance; and
the second power contact includes a first and a second half, the first half of the second power contact having a first and a second projection formed thereon, and the second half of the second power contact having a first and a second hole formed therein that each receive an associated one of the projections of the second power contact when the first half of the second power contact is stacked against the second half of the second power contact, the projections formed on the first half of the second power contact being spaced apart by a second distance different that the first distance.
